(19) United States
(12) Patent Application Publication
(10) Pub. No.: US 2025/0118898 A1
(43) Pub. Date: Apr. 10, 2025

(54) Flexible Antennas

(71) Applicant: Laird Connectivity LLC, Akron, OH (US)

(72) Inventors: Jason K. Olson, West Bend, WI (US); Mark R. WOLSKI, Saukville, WI (US); Adam T. Engelbrecht, Manitowoc, WI (US); Brian E. PETTED, Cedarburg, WI (US)

(21) Appl. No.: 18/378,467

(22) Filed: Oct. 10, 2023

Related U.S. Application Data
(60) Provisional application No. 63/428,403, filed on Nov. 28, 2022.

(51) Int. Cl. H01Q 9/04; H01Q 1/12

(52) U.S. Cl. CPC H01Q 9/0421; H01Q 1/125

(57) ABSTRACT

Exemplary embodiments are disclosed of flexible antennas, such as flexible planar inverted “F” antenna (PIFAs), inverted flexible PIFAs, flexible elevated notch antennas, flexible freestanding PIFAs, antenna systems including the same, etc. In exemplary embodiments, an inverted flexible PIFA includes a bottom-side radiating element and is configured for an inverted mount to a mounting surface whereby a radiation pattern of the bottom-side radiating element is directed outwardly away from the mounting surface.

### CROSS-REFERENCE TO RELATED APPLICATION

This application claims the benefit of and priority to U.S. Provisional Application No. 63/428,403 filed Nov. 28, 2022. The entire disclosure of this provisional application is incorporated herein by reference.

### FIELD

The present disclosure relates to flexible antennas, such as flexible planar inverted “F” antennas (PIFAs), etc.

### BACKGROUND

This section provides background information related to the present disclosure which is not necessarily prior art.

The need for planar antennas has grown tremendously due to the proliferation of all kinds of hand-held and portable wireless devices where the area reserved for antenna location continues to shrink. This need has been met by planar antennas, especially those known as planar inverted “F” antennas, or PIFAs.

FIG. 1 illustrates a conventional PIFA 10 comprising a main conductive element 12 positioned in a parallel position above a ground plate 14. A short circuit plate or pin 16 is located on aligned sides of the main element 12 and the ground plate 14. An antenna feed point 18 is formed on the main element 12. PIFAs are typically attached to flat surfaces 17 as shown in FIG. 1.

### DRAWINGS

The drawings described herein are for illustrative purposes only of selected embodiments and not all possible implementations, and are not intended to limit the scope of the present disclosure.

FIG. 1 illustrates a conventional planar inverted “F” antenna (PIFA).

FIG. 2 illustrates an inverted flexible PIFA including a bottom-side radiating element and configured for an inverted mount for outward radiation according to an exemplary embodiment of the present disclosure.

FIG. 3 illustrates a flexible PIFA including alternate antenna launch options including a cable launch and solder tab launch according to an exemplary embodiment of the present disclosure.

FIG. 4 illustrates a freestanding flexible PIFA including air between the radiating element and the ground plane according to an exemplary embodiment of the present disclosure.

FIG. 5 illustrates a flexible elevated notch antenna according to an exemplary embodiment of the present disclosure.

FIG. 6 illustrates an antenna system that includes an inverted flexible PIFA having a bottom-side radiating element and a flexible PIFA having a top-side radiating element according to an exemplary embodiment of the present disclosure.

FIG. 7 illustrates the downwardly and upwardly directed radiation from the respective inverted flexible PIFA and the flexible PIFA and away from mounting substrate surface, thereby providing the antenna system with dissimilar (uncorrelated) radiated patterns for coverage redundancy for diversity and MIMO operations.

FIGS. 8, 9, and 10 show an inverted flexible PIFA according to exemplary embodiments of the present disclosure.

FIG. 11 illustrates the inverted flexible PIFA shown in FIG. 10 with example physical dimensions in millimeters (mm) including a length of 40.7 mm, a width or height of 11 mm, a thickness of 2.5 mm, and a 100 mm long cable. The example dimensions provided in FIG. 11 are for purpose of illustration only as other exemplary embodiments of the inverted flexible PIFA may be configured with different physical dimensions, e.g., longer, shorter, wider, narrower, thicker, thinner, and/or with a longer or shorter cable, etc.

FIG. 12 illustrates an exemplary embodiment in which two inverted flexible PIFAs are internally adhesively mounted to the inside of a forward or top-facing part of an enclosure. The inverted flexible PIFAs are configured to radiate on (e.g., outwardly relative to, etc.) their adhesive side and provide superior performance and reliability in this orientation, thereby providing another option for mounting wireless 2.4 GHz antennas inside enclosures, etc.

Corresponding reference numerals may indicate corresponding (although not necessarily identical) parts throughout the several views of the drawings.

### APPENDIX A

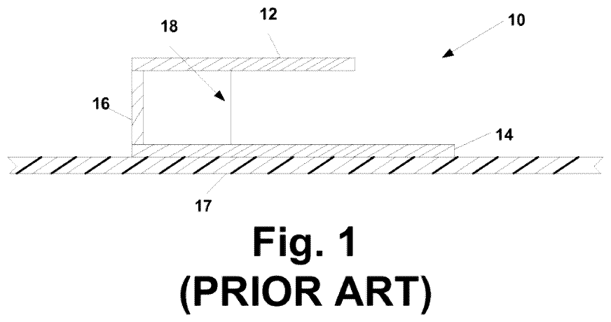

Appendix A includes line graphs, radiation pattern 2D plots, and radiation pattern 3D plots for the inverted flexible PIFA shown in FIG. 1 of the Appendix A. The contents of Appendix A is incorporated herein by reference in its entirety.

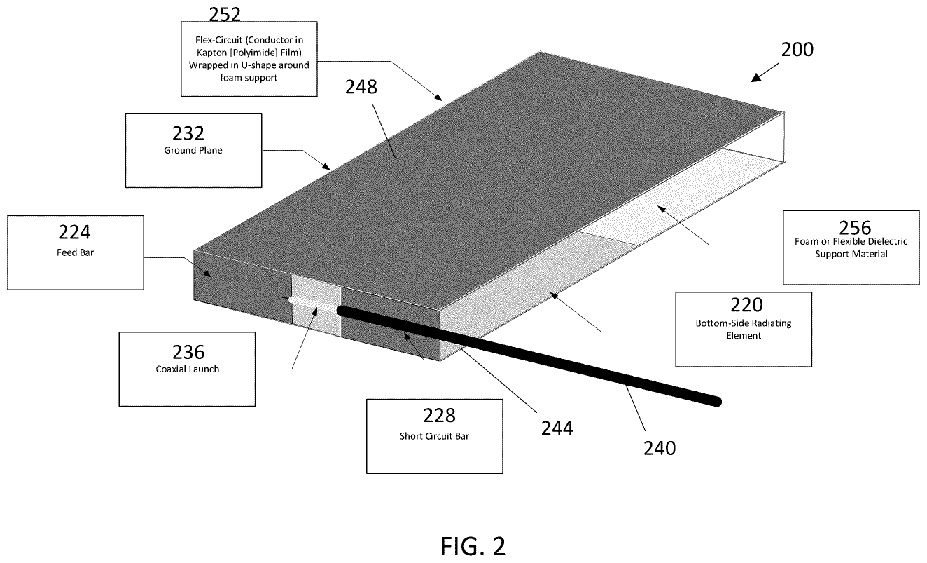

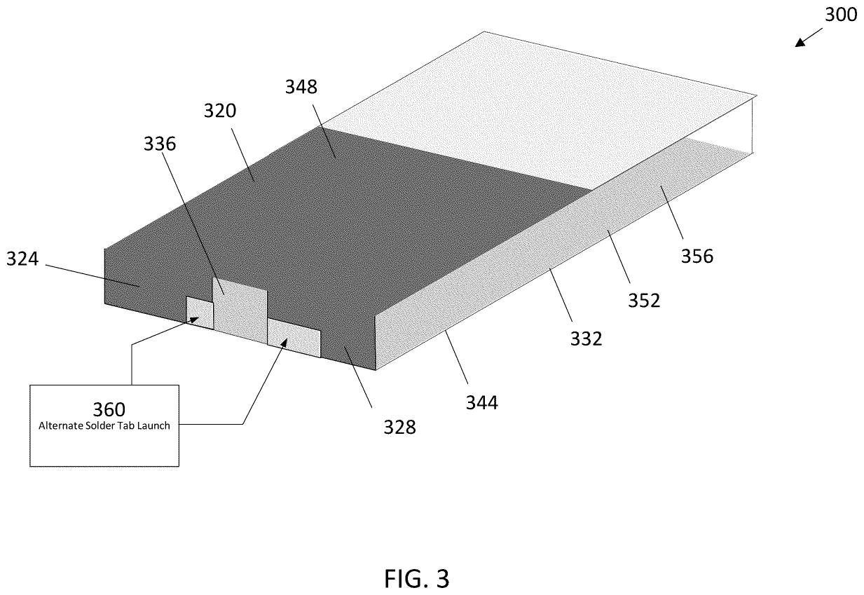

Appendix A includes the following figures. FIG. 1 illustrates an inverted flexible PIFA including physical dimensions in millimeters with a 100 mm long cable. FIGS. 2 and 3 include flat surface antenna measurements with the inverted flexible PIFA centered on a 1.5 mm thick plate of polycarbonate. More specifically, FIG. 2 is a line graph of VSWR versus frequency (MHz) measured for the inverted flexible PIFA while centered on the 1.5 mm thick plate of polycarbonate with a nominal value of 1.45 across a sample size mounted on 1 mm-3 mm polycarbonate and both MHF1/MHF4L connector options. FIG. 3 is a line graph of return loss (S11 dB) versus frequency (MHz) measured for the inverted flexible PIFA while centered on the 1.5 mm thick plate of polycarbonate with a nominal value of −22.3 dB.

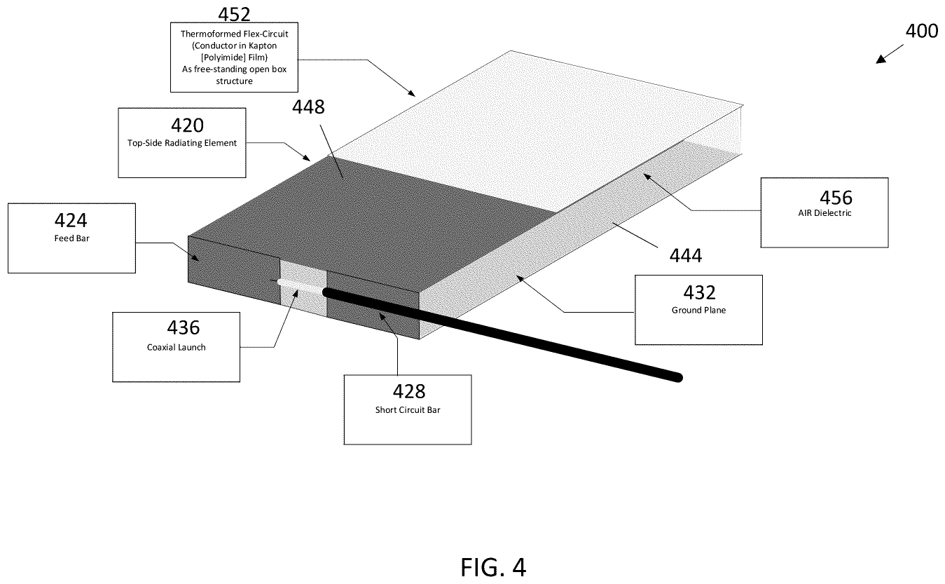

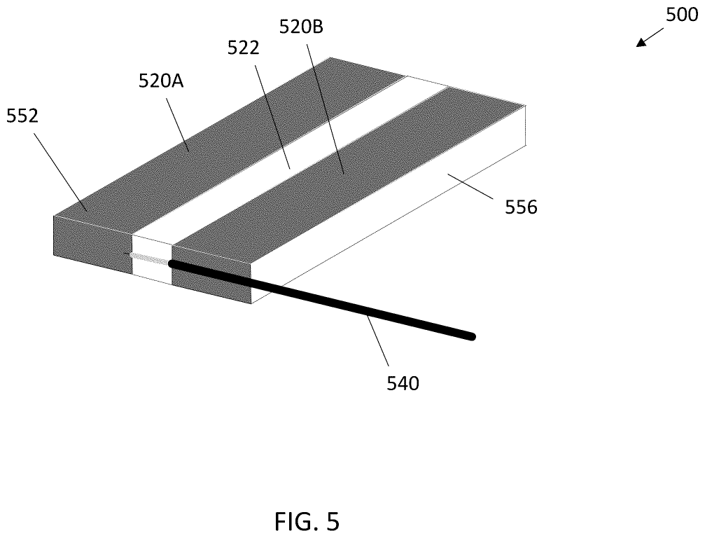

FIGS. 4 and 5 show an antenna chamber test set up in which antenna measurements such as VSWR (FIG. 2) and S11 (FIG. 3) were measured with an Agilent E5071C vector network analyzer. Radiation patterns were measured with a Rohde & Schwarz ZNB8-4PORT vector network analyzer in a Howland Company 3100 chamber equivalent. Phase center is nine inches above the Phi positioner. More specifically, FIG. 4 shows the antenna chamber. FIG. 5 shows the flat surface setup with the inverted flexible PIFA centered on a 1.5 mm thick plate of polycarbonate.

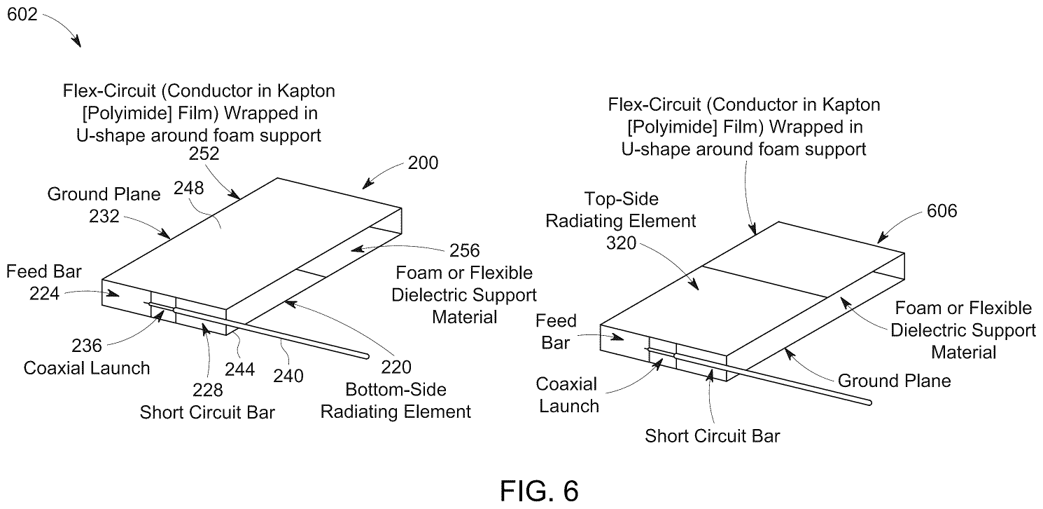

FIG. 6 is a line graph of efficiency (%) versus frequency (MHz) measured for the inverted flexible PIFA while centered on the 1.5 mm thick plate of polycarbonate with a nominal value of −2.0 dB across the operating frequency.

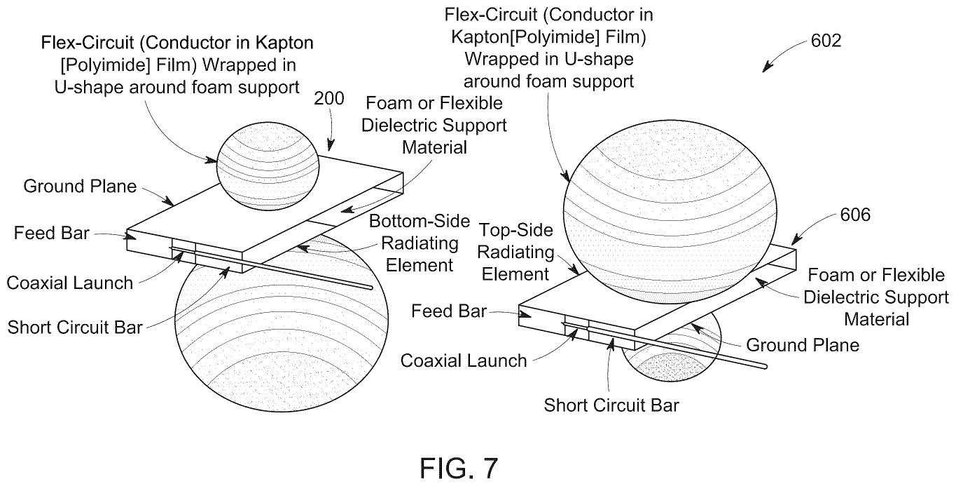

FIG. 7 is a line graph of gain (dBi) versus frequency (MHz) measured for the inverted flexible PIFA while centered on the 1.5 mm thick plate of polycarbonate with a nominal value of 2.8 dBi across the operating frequency.

Appendix A also includes radiation pattern 2D plots and 3D plots at 2400 MHZ, 2440 MHz, and 2480 MHz for the inverted flexible PIFA.

The line graphs, radiation pattern 2D plots, and radiation pattern 3D plots shown in Appendix A are for illustrative purposes only as exemplary embodiments of the inverted flexible PIFAs disclosed herein may be configured differently and/or have different antenna performance than what is shown in Appendix A.

### DETAILED DESCRIPTION

Example embodiments will now be described more fully with reference to the accompanying drawings.

Disclosed herein are exemplary embodiments of inverted flexible PIFA antennas including bottom-side radiating elements and configured for an inverted mount for outward radiation with exceptional radio frequency (RF) performance. In exemplary embodiments, the inverted flexible PIFA is configured to deliver strong performance in challenging environments, providing unmatched flexibility to solve real-world antenna design challenges. In exemplary embodiments, the inverted flexible PIFA is configured to allow for rapid integration into space-constrained devices and housings. Exemplary embodiments include flexible, adhesive backed antennas that are available with MHF1 and MHF4 connector options, e.g., with a 100 millimeter (mm) cable length, etc.

In exemplary embodiments, the inverted flexible PIFA is configured such that its radiating element faces outward when adhered to an interior of a housing or enclosure (e.g., a plastic enclosure interior, etc.). This antenna orientation provides more flexibility by enabling different antenna mounting options for the inverted flexible PIFA, such as the underside of an enclosure, etc.

In exemplary embodiments, the inverted flexible PIFA is configured to provide consistent performance across the 2.4 GHz ISM band while ensuring a solid and reliable connection. In exemplary embodiments, the inverted flexible PIFA is configured to have the following:
Coverage—2.4 GHz-2.48 GHz Operation (e.g., 2400 MHz to 2485 MHz, etc.)
Performance—Exceptional performance with 3.1 dBi gain and 2.5:1 VSWR
Versatile—Flexible, peel-and-stick adhesive backed antenna for a variety of space-constrained IoT (Internet of Things) devices
Reliable—PIFA technology is readily integrable into IoT devices and less likely to detune in proximity of metal or a human body.
Quality—Design and built to exacting specifications.

In exemplary embodiments, the inverted flexible PIFA may be configured to have the following specifications. These specifications are provided only for purposes of illustration and not for purposes of limitation as other exemplary embodiments may be configured differently with better and/or different specifications. Also the specifications are based on a 100 mm cable length, standard antenna version with MHF1/U.FL connector. Varying the cable length or type of connector will cause variations in antenna specifications.

### Specifications

Operating Frequency (MHz) 2400-2480
Peak Gain (dBi)+3.1
Average Efficiency (dB)>−2.1
VSWR (Max)<2.5:1
Impedance (Ohms) 50
Polarization Linear
Antenna Type Inverted Ground Flexible Planar Inverted F Antenna
Radiation Pattern Omnidirectional
Dimensions—length×width×height mm (inches) 40.9×11×2.9 (1.61×0.43×0.114)
Weight—grams (ounces) 1.13 (0.040)
Color Clear Yellow
Adhesive 3M 100 MP
Connector Options and Mating Height (max) MHF1 (U.FL) 2.5 mm and MHF4L 1.4 mm
Operating Temperature—° C. (° F.)−40 to +85° C. (−40 to +185° F.)
Material Substance Compliance ROHS
Configuration 100 mm long cable with MHF1 connector or 100 mm long cable with MHF4 connector

Exemplary embodiments of the antennas disclosed herein may be used in various application areas, such as Industrial IoT, Smart Metering and Utilities, Rugged Handheld Scanners, Medical Devices, Electric Vehicle (EV) Charging Stations, Telematics/Logistics Devices, etc.

FIG. 2 illustrates an inverted flexible PIFA 200 including a bottom-side radiating element 220 according to an exemplary embodiment of the present disclosure. As shown, the inverted flexible PIFA 200 includes a feed bar or feed tab 224, a short circuit bar or ground tab 228, and a ground plane 232.

The feed bar 224 and short circuit bar 228 cooperatively define or provide a coaxial launch 236 for the inverted flexible PIFA 200. More specifically, the feed bar 224 and short circuit bar 228 are configured to be connected with (e.g., soldered to, etc.) the respective center and outer conductors of a cable 240 (e.g., coaxial cable, U.FL cable, etc.). The antenna feedpoint is located along the short edge of the inverted flexible PIFA 200, which short edge will experience the least amount of distortion when the main body of the inverted flexible PIFA 200 is bent or flexed, e.g., around a convexly curved surface, concavely curved surface, other non-flat surface, etc. The inverted flexible PIFA 200 may also include solders tabs that provide an alternative option to the coaxial launch 236. See, for example, the alternate solder tab launch 360 of the flexible PIFA 300 shown in FIG. 3.

The inverted flexible PIFA 200 includes the radiating element 220 along the bottom side 244 of the inverted flexible PIFA 200. The bottom side 244 of the inverted flexible PIFA 200 is also configured for mounting the inverted flexible PIFA 200 to a mounting surface or support structure. For example, the PIFA's bottom side 244 may include or be provided with an adhesive (e.g., peel-and-stick adhesive with a release sheet, etc.) for adhesively attaching the PIFA's bottom side 244 to a curved or non-flat mounting surface. Accordingly, the flexible, adhesive backed inverted PIFA 200 is thus configured with an inverted mount for outward radiation.

With continued reference to FIG. 2, the ground plane 232 is along the top side 248 of the inverted flexible PIFA 200. The radiating element 220 and ground plane 232 may comprise electrically-conductive portions or electrical conductors (e.g., copper layer, other metal layer, an electrically-conductive non-metal layer, etc.) of a flexible circuit 252. For example, the inverted flexible PIFA 200 may comprise a flex circuit including electrical conductor(s) defining the radiating element 220 and ground plane 232 in a KAPTON polyimide film or other flexible dielectric material, etc. The radiating element 220 and the ground plane 232 may comprise a metal layer (e.g., copper layer, etc.) along opposite ends of a flexible dielectric substrate that are covered by cover layer (e.g., a flexible dielectric material, thin layer of paint, etc.).

The flexible circuit 252 may be folded, wrapped, bent, or otherwise configured (e.g., into a U-shape, etc.) such that the radiating element 220 is along the PIFA's bottom side 244 and the ground plane 232 is along the PIFA's top side 248. The top-side radiating element 220 and the bottom-side ground plane 232 are spaced apart and generally parallel to each other.

A dielectric 256 (e.g., a foam, ethyl vinyl acetate foam, other flexible dielectric support material, air, etc.) is between the top-side radiating element 220 and the bottom-side ground plane 232. For example, the flexible circuit 252 may be folded or wrapped around a flexible dielectric material 256 (e.g., foam, etc.) such that the top-side radiating element 220 and the bottom-side ground plane 232 are spaced apart and generally parallel to each other with the flexible dielectric material 256 between the top-side radiating element 220 and the bottom-side ground plane 232. The flexible circuit 252 may be adhesively attached to the flexible dielectric material 256. In other exemplary embodiments, the flexible circuit 252 may be configured (e.g., thermoformed, etc.) to be freestanding/self-supporting and with air as the dielectric 256. For example, FIG. 4 illustrates an exemplary embodiment of a freestanding flexible PIFA 400 comprising a thermoformed freestanding box structure in which air is the dielectric 456 between the top-side radiating element 420 and the bottom-side ground plane 432.

FIG. 3 illustrates a flexible PIFA 300 including alternate antenna launch options including a cable launch 336 and solder tab launch 360 according to an exemplary embodiment of the present disclosure. Similar to the inverted flexible PIFA 200 shown in FIG. 2, this exemplary embodiment of the PIFA 300 includes a feed tab or bar 324 for connection (e.g., via solder, etc.) with a center conductor of a cable (e.g., coaxial cable, U.FL cable, etc.). The PIFA 300 also includes a ground tab or short circuit bar 328 for connection with an outer conductor of the cable. In addition to the feed tab or bar 324 and the ground tab or short circuit bar 328, the PIFA 300 further includes solder tabs 360 to provide an alternative option for connecting an antenna feed to the PIFA 300.

In this illustrated embodiment, the flexible PIFA 300 includes a radiating element 320 along the PIFA's top side 348 and a ground plane 332 along the PIFA's bottom side 344. Alternatively, the flexible PIFA 300 may be inverted such that the radiating element 320 is along the PIFA's bottom side 344 and the ground plane 332 is along the PIFA's top side 348, such as shown in FIG. 2 for the inverted flexible PIFA 200.

The bottom side 344 of the flexible PIFA 300 is also configured for mounting the flexible PIFA 300 to a mounting surface or support structure. For example, the PIFA's bottom side 344 may include or be provided with an adhesive (e.g., peel-and-stick adhesive with a release sheet, etc.) for adhesively attaching the PIFA's bottom side 344 to a curved or non-flat mounting surface.

Similar to the radiating element 220 and ground plane 232, the radiating element 320 and ground plane 332 of the flexible PIFA 300 may also comprise electrically-conductive portions or electrical conductors (e.g., copper layer, other metal layer, an electrically-conductive non-metal layer, etc.) of a flexible circuit. For example, the flexible PIFA 300 may comprise a flex circuit 352 including electrical conductor(s) defining the radiating element 320 and ground plane 332 in a KAPTON polyimide film or other flexible dielectric material, etc. The flexible circuit 352 may be folded, wrapped, bent, or otherwise configured (e.g., into a U-shape, etc.) such that the radiating element 320 is along the PIFA's top side 348 and the ground plane 332 is along the PIFA's bottom side 344, or vice versa.

A dielectric 356 (e.g., a foam, ethyl vinyl acetate foam, other flexible dielectric support material, air, etc.) is between the radiating element 320 and the ground plane 332. For example, the flexible circuit 352 may be folded or wrapped around a flexible dielectric material 356 (e.g., foam, etc.) such that the radiating element 320 and the bottom-side ground plane 332 are spaced apart and generally parallel to each other with the flexible dielectric material 356 between the radiating element 320 and the ground plane 332. The flexible circuit 352 may be adhesively attached to the flexible dielectric material 356. In other exemplary embodiments, the flexible circuit 352 may be configured (e.g., thermoformed, etc.) to be freestanding/self-supporting and with air as the dielectric 356.

FIG. 4 illustrates an exemplary embodiment of a freestanding/self-supporting flexible PIFA 400 comprising a thermoformed freestanding/self-supporting box structure in which air is the dielectric 456 between the top-side radiating element 420 and the bottom-side ground plane 432.

Similar to the inverted flexible PIFA 200 shown in FIG. 2, this exemplary embodiment of the freestanding flexible PIFA 400 includes a feed tab or bar 424 for connection (e.g., via solder, etc.) with a center conductor of a cable (e.g., coaxial cable, U.FL cable, etc.). The PIFA 400 also includes a ground tab or short circuit bar 428 for connection with an outer conductor of the cable. The feed bar 424 and short circuit bar 428 cooperatively define or provide a coaxial launch 436 for the freestanding flexible PIFA 400. The freestanding flexible PIFA 400 may also include solders tabs that provide an alternative option to the coaxial launch 436. See, for example, the alternate solder tab launch 360 of the flexible PIFA 300 shown in FIG. 3.

In this illustrated embodiment, the radiating element 420 is along the PIFA's top side 448. And the ground plane 432 is along the PIFA's bottom side 444. Alternatively, the freestanding flexible PIFA 400 may be inverted such that the radiating element 420 is along the PIFA's bottom side 444 and the ground plane 432 is along the PIFA's top side 448, such as shown in FIG. 2 for the inverted flexible PIFA 200.

The bottom side 444 of the freestanding flexible PIFA 400 is also configured for mounting the freestanding flexible PIFA 400 to a mounting surface or support structure. For example, the PIFA's bottom side 444 may include or be provided with an adhesive (e.g., peel-and-stick adhesive with a release sheet, etc.) for adhesively attaching the PIFA's bottom side 444 to a mounting surface.

The freestanding flexible PIFA 400 comprises a thermoformed freestanding box structure in which air is the dielectric 456 between the top-side radiating element 420 and the bottom-side ground plane 432. The radiating element 420 and ground plane 432 of the freestanding flexible PIFA 400 may comprise electrically-conductive portions or electrical conductors (e.g., copper layer, other metal layer, an electrically-conductive non-metal layer, etc.) of a thermoformed flex circuit 452. For example, the thermoformed flex circuit 452 may include electrical conductor(s) defining the radiating element 420 and ground plane 432 in a KAPTON polyimide film or other flexible dielectric material, etc.

The flex circuit 452 is thermoformed to make rigid bends in order to support a freestanding open box structure as shown in FIG. 4. The freestanding/self-supporting structure allows air to be used as the dielectric between the radiating element 420 and the ground plane 432 as a foam support is not necessary or required. The thermoformed flex circuit 452 is open along both sides. The free ends of the flex circuit 452 may be attached (e.g., adhesively attached, etc.) to each other such that the thermoformed flex circuit 452 is freestanding and self-supporting without requiring an internal foam support. The use of air as the dielectric instead of foam may allow for better antenna performance and more flexibility to a larger radius of curvature.

FIG. 5 illustrates an exemplary embodiment of a flexible antenna 500 including an elevated notch antenna and without requiring a ground plane. In this exemplary embodiment, the flexible antenna 500 includes antenna radiating elements 520A, 520B along opposite sides of a slot 522 (e.g., defined by absence of electrically-conductive material along a flex circuit, etc.).

A cable 540 (e.g., coaxial cable, U.FL cable, etc.) is coupled to both antenna elements 520A, 520B on opposite sides of the slot 522. More specifically, the center conductor of the cable 540 is coupled (e.g., soldered, etc.) with the antenna element 520A. And the outer conductor of the cable 540 is coupled (e.g., soldered, etc.) with the antenna element 520B. The antenna feedpoint is located along the short edge of the flexible antenna 500, which short edge will experience the least amount of distortion when the main body of the flexible antenna 500 is bent or flexed, e.g., around a convexly curved surface, concavely curved surface, other non-flat surface, etc. The flexible antenna 500 may also include solders tabs that provide an alternative option. See, for example, the alternate solder tab launch 360 of the flexible PIFA 300 shown in FIG. 3.

The flexible antenna 500 may comprise a flex circuit 552 to implement the antenna elements 520A, 520B, and slot 522. For example, the antenna elements 520A and 520B may comprise or be defined by electrically-conductive portions or electrical conductors (e.g., copper layer, other metal layer, an electrically-conductive non-metal layer, etc.) of a flex 552. And the slot 522 may comprise or be defined by a dielectric portion of the flex circuit between the antenna elements 520A and 520B. The flex circuit 552 may include electrical conductor(s) defining the antenna elements 520A, 520B in a KAPTON polyimide film or other flexible dielectric material, etc. The flex circuit 552 may be folded, wrapped, bent, or otherwise configured (e.g., into a U-shape, etc.) around a flexible dielectric material 556 (e.g., foam, etc.). The flex circuit 552 may be adhesively attached to the flexible dielectric material 556. In other exemplary embodiments, the flex circuit 552 may be configured (e.g., thermoformed, etc.) to be freestanding/self-supporting and with air as the dielectric 556.

By way of example, an antenna system (e.g., diversity antenna array, MIMO antenna array, etc.) may include one or more of the antennas disclosed herein (e.g., inverted flexible PIFA antenna 200 (FIG. 2), flexible PIFA 300 (FIG. 3), freestanding flexible PIFA antenna 400 (FIG. 4), flexible elevated notch antenna 500 (FIG. 5), etc.) in combination with a flexible PIFA disclosed in U.S. Pat. No. 9,450,307, which is incorporated herein by reference in its entirety.

FIG. 6 illustrates an exemplary embodiment of an antenna system 602 that includes an inverted flexible PIFA 200 (FIG. 2) having a bottom-side radiating element 220 as disclosed herein. The antenna system 602 also includes a flexible PIFA 606 having a top-side radiating element 620 and that may be substantially identical or similar to the flexible PIFA 300 described above and shown in FIG. 3. The illustrated components of the antenna system 602 may be substantially similar or identical to the corresponding components of the inverted flexible PIFA 200 (FIG. 2) and the flexible PIFA 300 (FIG. 3), although this is not required for all exemplary embodiments. For brevity, a detailed description of the corresponding components of the inverted flexible PIFA 200 (FIG. 2) and the flexible PIFA 300 (FIG. 3) will not be repeated.

For diversity and MIMO operation, antennas must have dissimilar (uncorrelated) radiated patterns for coverage redundancy. As shown in FIG. 7, the inverted flexible PIFA 200 is configured such that its radiation is mainly directed down and away from mounting substrate surface. And the flexible PIFA 606 is configured such that its radiation is mainly directed up and away from mounting substrate surface. This advantageously provides the antenna system 602 with dissimilar (uncorrelated) radiated patterns for coverage redundancy for diversity and MIMO operations.

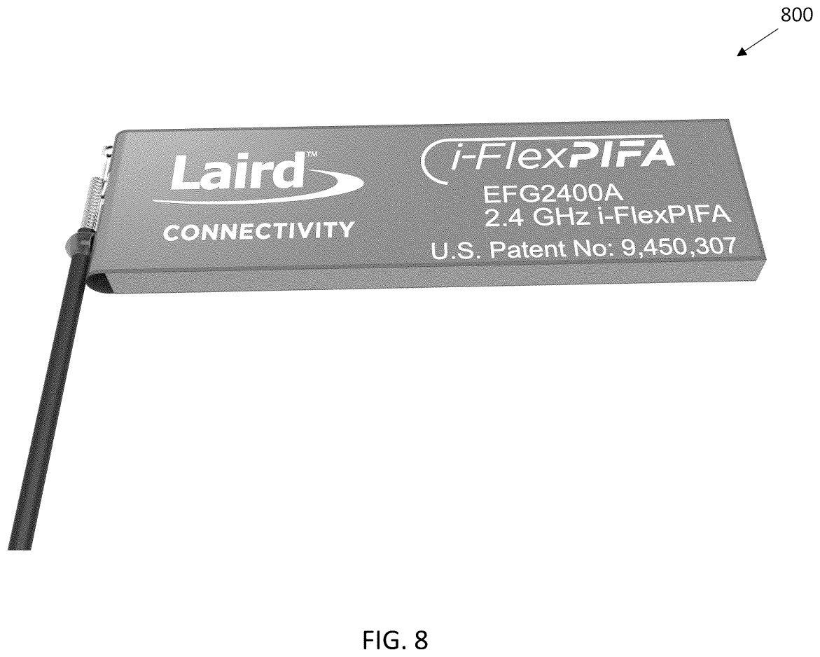

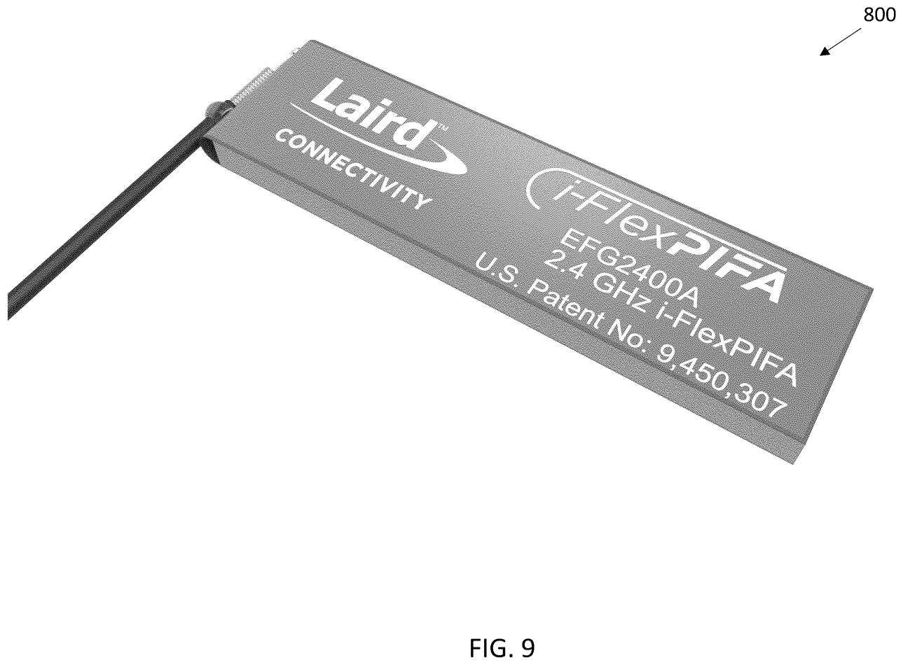

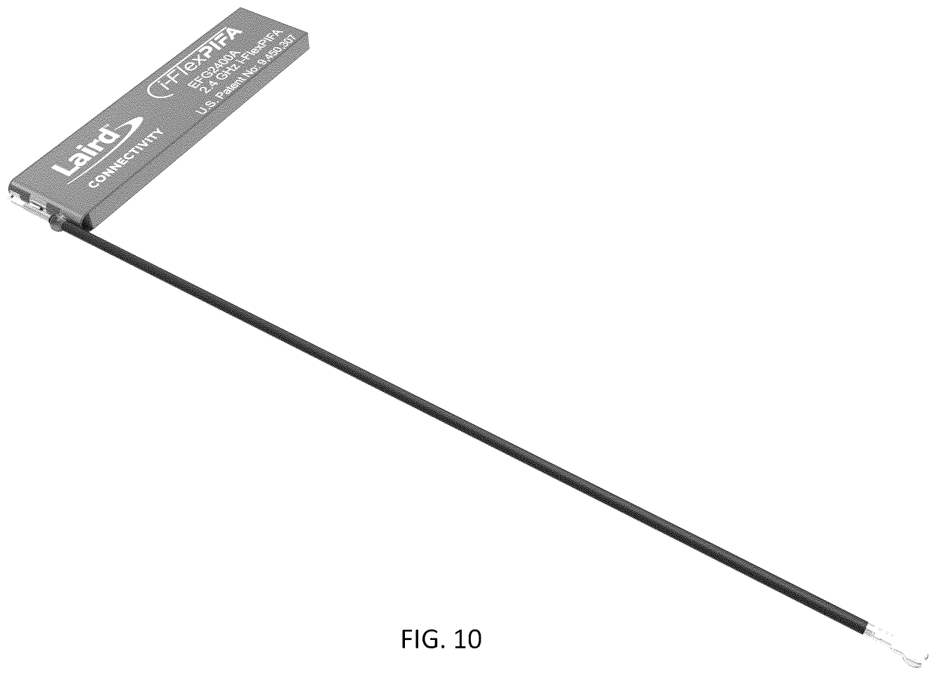

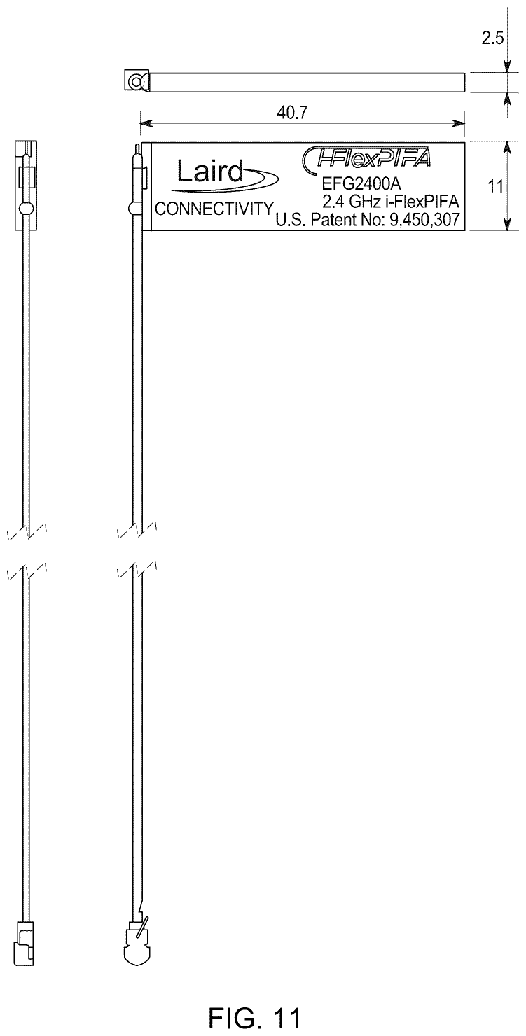

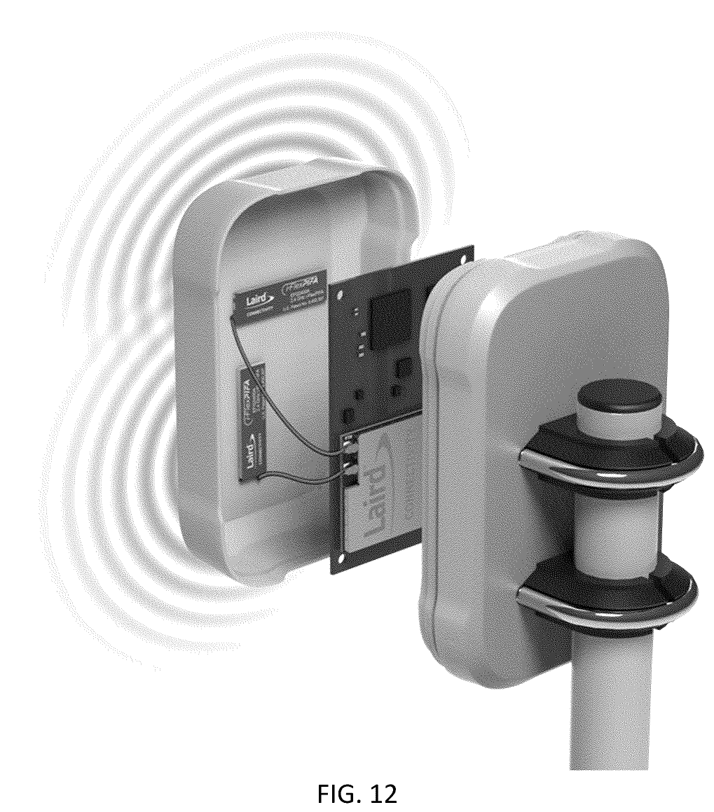

FIGS. 8, 9, and 10 show an inverted flexible PIFA 800 according to an exemplary embodiment of the present disclosure. In this exemplary embodiment, the PIFA 800 may include a bottom-side radiating element, a feed bar or feed tab, a short circuit bar or ground tab, a top-side ground plane, and a flex circuit as disclosed herein for the inverted flexible PIFA 200 shown in FIG. 2. For example, the PIFA 800 may include a flex circuit comprising electrical conductor(s) defining the bottom-side radiating element and top-side ground plane in a KAPTON polyimide film or other flexible dielectric material, etc. For brevity, a detailed description of the corresponding components of the inverted flexible PIFA 200 (FIG. 2) will not be repeated.

The PIFA 800 may be configured to resist de-tuning when physically flexed, to be less sensitive to the presence of a living body in the near field, and to be less sensitive to the presence of metal than conventional antennas. The PIFA 800 may be configured for operation in the 2.4-2.48 GHz frequency band. Alternatively, other exemplary embodiments may include a flexible PIFA configured for dual use in the 2.4-2.48 GHz frequency band and the 5.15-5.85 GHz frequency band.

Advantageously, exemplary embodiments of the flexible antennas disclosed herein (e.g., inverted flexible PIFA antenna 200 (FIG. 2), flexible PIFA 300 (FIG. 3), freestanding flexible PIFA antenna 400 (FIG. 4), flexible elevated notch antenna 500 (FIG. 5), etc.) may be sufficiently flexible such that the flexible antenna may be used various kinds of articles (e.g., curved enclosures, wearables, etc.) that do not include flat surfaces for mounting without degrading the flexible antenna performance. In addition, exemplary embodiments of the flexible antennas disclosed herein (e.g., inverted flexible PIFA antenna 200 (FIG. 2), flexible PIFA 300 (FIG. 3), freestanding flexible PIFA antenna 400 (FIG. 4), flexible elevated notch antenna 500 (FIG. 5), etc.) may be configured to be less sensitive to the presence of a living body in the near field and less sensitive to the presence of metal than the conventional PIFA 10 shown in FIG. 1.

Exemplary embodiments may be configured to allow for top and bottom-side antenna element pattern placement, allow for other antenna types on the same mechanical structure (e.g., flex circuit, flexible support materials, etc.), allow for alternate launch methods (e.g., coaxial cable launch and solder tab launch, etc.), allow for other flexible support materials besides foam including air in self-supporting/freestanding structures, allow for alternate antenna topologies on flexible structures, and/or allow for radiation patterns in opposite directions (e.g., upward and downward radiation patterns as shown in FIG. 7, etc.).

Exemplary embodiments disclosed herein may provide flexible antenna solutions for in-situ integration into plastic electronic product packaging. Exemplary embodiments disclosed herein may be configured to provide alternate antenna patterns for flexible PIFAs, e.g., in order to steer peak directivity away from certain mechanical structures in certain packaging applications, etc. For example, exemplary embodiments disclosed herein may be configured to include a reversed antenna pattern that offers a reversed aperture version of a flexible PIFA disclosed in U.S. Pat. No. 9,450,307, which is incorporated herein by reference in its entirety. The reversed antenna pattern may be more advantageous to the relative mechanical arrangement of a particular packaging scheme.

Exemplary embodiments disclosed herein may include or provide one or more (but not necessarily any or all) of the following features and benefits:
Quick and easy installation
Adhesive holds to surface during humidity exposure and hot/cold cycles
RoHS-compliant
Radiation direction maximized on adhesive side for outward-facing orientation
Can be installed in various ways:
   On different non-conductive surfaces and thicknesses
   On flat or curved surfaces
   MIMO array element
   On the front or top face of an enclosure interior.

In exemplary embodiments, an inverted flexible planar inverted “F” antenna (PIFA) comprises a bottom-side radiating element. The inverted flexible PIFA is configured for an inverted mount to a mounting surface. A radiation pattern of the bottom-side radiating element is directed outwardly away from the mounting surface when the inverted flexible PIFA is mounted to the mounting surface.

In exemplary embodiments, the inverted flexible PIFA comprises a bottom-side adhesive for adhesively mounting the inverted flexible PIFA to a mounting surface. The bottom-side radiating element is configured to radiate outwardly through the bottom-side adhesive and the mounting surface when the inverted flexible PIFA is adhesively mounted to the mounting surface via the bottom-side adhesive.

In exemplary embodiments, the inverted flexible PIFA comprises a bottom side including inner and outer surfaces. An adhesive is along the outer surface of the bottom side for adhesively mounting the bottom side of inverted flexible PIFA to a mounting surface. The bottom-side radiating element is along the inner surface of the bottom side such that the bottom-side radiating element is configured to radiate outwardly through bottom side and the adhesive along the outer surface of the bottom side. For example, the inverted flexible PIFA may be internally adhesively mountable, via the adhesive, along an inner surface of a forward-facing part of an enclosure, whereby the bottom-side radiating element is operable for radiating forwardly through the forward-facing part of the enclosure when the inverted flexible PIFA is adhesively mounted to the inner surface of the forward-facing part of the enclosure. Or, for example, the inverted flexible PIFA may be internally adhesively mountable, via the adhesive, along an inner surface of a top-facing part of an enclosure, whereby the bottom-side radiating element is operable for radiating upwardly through the top-facing part of the enclosure when the inverted flexible PIFA is adhesively mounted to the inner surface of the top-facing part of the enclosure.

In exemplary embodiments, the inverted flexible PIFA comprises a flexible printed circuit board (PCB) having a metal layer on a first side that is covered by a cover layer. The flexible PCB comprises a second side opposite the first side. And the second side is foldable or bendable to form the bottom-side radiating element and a top-side ground plane spaced apart from and/or generally parallel to each other such that the bottom-side radiating element and the top-side ground plane are defined by the flexible PCB.

In exemplary embodiments, the second side is foldable or bendable relative to a dielectric to form the bottom-side radiating element and the top-side ground plane spaced apart from and/or generally parallel to each other. The dielectric comprises may comprise foam or air.

In exemplary embodiments, the inverted flexible PIFA comprises a flexible dielectric element around which the second side is foldable or bendable to form the bottom-side radiating element and the top-side ground plane spaced apart from and/or generally parallel to each other.

In exemplary embodiments, the flexible PCB is configured such that the inverted flexible PIFA is freestanding and/or self-supporting such that air is the only dielectric between the bottom-side radiating element and the top-side ground plane.

In exemplary embodiments, the inverted flexible PIFA comprises an antenna performance when electrically connected to a wireless device that is maintained when the flexible PCB is bent into a concave shape or into a convex shape.

In exemplary embodiments, the inverted flexible PIFA comprises a cable having a first end electrically connected to the metal layer and having a second end adapted to electrically connect to a wireless device.

In exemplary embodiments, the inverted flexible PIFA comprises a flex circuit that includes or defines the bottom-side radiating element and a top-side ground plane spaced apart from and/or generally parallel to the bottom-side radiating element.

In exemplary embodiments, the flex circuit is foldable or bendable into a generally U-shaped configuration in which the bottom-side radiating element and the top-side ground plane are spaced apart from and/or generally parallel to each other.

In exemplary embodiments, the inverted flexible PIFA comprises an antenna performance when electrically connected to a wireless device that is maintained when the flex circuit is bent into a concave shape or into a convex shape.

In exemplary embodiments, the flex circuit comprises polyimide film and electrical conductor(s) in the polyimide film defining the bottom-side radiating element and the top-side ground plane.

In exemplary embodiments, the flex circuit is foldable or bendable relative to a dielectric to form the bottom-side radiating element and the top-side ground plane spaced apart from and/or generally parallel to each other. The dielectric may comprise foam or air.

In exemplary embodiments, the inverted flexible PIFA comprises a flexible dielectric element around which the flex circuit is foldable or bendable to form the bottom-side radiating element and the top-side ground plane spaced apart from and/or generally parallel to each other.

In exemplary embodiments, the flex circuit is configured such that the inverted flexible PIFA is freestanding and/or self-supporting such that air is the only dielectric between the bottom-side radiating element and the top-side ground plane.

In exemplary embodiments, the flex circuit is thermoformed such that the inverted flexible PIFA is freestanding and/or self-supporting without requiring a flexible dielectric support between the bottom-side radiating element and the top-side ground plane.

In exemplary embodiments, the inverted flexible PIFA comprises a coaxial launch and an alternative solder tab launch located along an edge of the inverted flexible PIFA that connects the bottom-side radiating element and a top-side ground plane of the inverted flexible PIFA for reducing distortion of an antenna feedpoint when the inverted flexible PIFA is bent into a concave shape or into a convex shape.

In exemplary embodiments, the inverted flexible PIFA is configured to be operable with an antenna performance when electrically connected to a wireless device that is maintained when the inverted flexible PIFA is in use.

In exemplary embodiments, an antenna system comprises an inverted flexible PIFA and a flexible PIFA including a top-side radiating element. The antenna system is configured such that the bottom-side radiating element of the inverted flexible PIFA and the top-side radiating element of the flexible PIFA are respectively operable with oppositely directed radiation outwardly away from a mounting surface, thereby providing the antenna system with dissimilar (uncorrelated) radiated patterns for coverage redundancy for diversity and MIMO operations.

In exemplary embodiments, a flexible PIFA comprises a flex circuit defining a radiating element and a ground plane spaced apart from and/or generally parallel with the radiating element. The flex circuit is configured and/or thermoformed such that the flexible PIFA is freestanding and/or self-supporting without requiring a flexible dielectric support between the radiating element and the ground plane, thereby allowing the use of air as the only dielectric between the radiating element and the ground plane.

Also disclosed is an exemplary method for providing a flexible planar inverted “F” antenna (PIFA) that includes a flexible printed circuit board (PCB) having a metal layer on a first side that is covered by a cover layer and that can operate when secured to a curved surface. The exemplary method comprises folding a second side of the flexible PCB that is opposite the first side to form a bottom-side radiating element and a top-side ground plane that are spaced apart from and/or generally parallel to each other such that the bottom-side radiating element and the top-side ground plane are defined by the flexible PCB.

The exemplary method may include securing the bottom side of the flexible PIFA to a curved mounting surface, whereby said flexible PIFA is operable with an antenna performance when electrically connected to a wireless device that is maintained while said flexible PIFA is in use. The exemplary method may include folding the flexible PCB around a flexible dielectric element to thereby form the bottom-side radiating element and the top-side ground plane spaced apart from and/or generally parallel to each other.

An exemplary method for providing a flexible planar inverted “F” antenna (PIFA) that includes a flex circuit is also disclosed. The method comprises folding the flex circuit to form a bottom-side radiating element and a top-side ground plane that are spaced apart from and/or generally parallel to each other such that the bottom-side radiating element and the top-side ground plane are defined by the flex circuit.

The exemplary method may include securing a bottom side of the flexible PIFA to a curved mounting surface. The flexible PIFA is operable with an antenna performance when electrically connected to a wireless device that is maintained while said flexible PIFA is in use. The exemplary method may include folding the flex circuit around a flexible dielectric element to thereby form the bottom-side radiating element and the top-side ground plane spaced apart from and/or generally parallel to each other. The exemplary method may include thermoforming the flex circuit such that the flexible PIFA is freestanding and/or self-supporting without requiring a flexible dielectric support between the bottom-side radiating element and the top-side ground plane, thereby allowing the use of air as a dielectric between the bottom-side radiating element and the top-side ground plane.

An exemplary method is disclosed for providing a flexible planar inverted “F” antenna (PIFA) that includes a flex circuit. The exemplary method comprises thermoforming the flex circuit to form a radiating element and a ground plane that are spaced apart from and/or generally parallel to each other such that the radiating element and the ground plane are defined by the flex circuit. The flexible PIFA is freestanding and/or self-supporting without requiring a flexible dielectric support between the radiating element and the ground plane, thereby allowing the use of air as the only dielectric between the radiating element and the ground plane.

The exemplary method may include securing the flexible PIFA to a curved mounting surface, whereby said flexible PIFA is operable with an antenna performance when electrically connected to a wireless device that is maintained while said flexible PIFA is in use.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a.” “an,” and “the” may be intended to include the plural forms as well, unless the context clearly indicates otherwise. The terms “comprises,” “comprising.” “including.” and “having.” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “bottom”, “top”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An inverted flexible planar inverted “F” antenna (PIFA) comprising a bottom-side radiating element, the inverted flexible PIFA configured for an inverted mount to a mounting surface whereby a radiation pattern of the bottom-side radiating element is directed outwardly away from the mounting surface when the inverted flexible PIFA is mounted to the mounting surface.

2. The inverted flexible PIFA of claim 1, wherein the inverted flexible PIFA comprises a bottom-side adhesive for adhesively mounting the inverted flexible PIFA to a mounting surface whereby the bottom-side radiating element is configured to radiate outwardly through the bottom-side adhesive and the mounting surface when the inverted flexible PIFA is adhesively mounted to the mounting surface via the bottom-side adhesive.

3. The inverted flexible PIFA of claim 1, wherein:
the inverted flexible PIFA comprises a bottom side including inner and outer surfaces, and an adhesive along the outer surface of the bottom side for adhesively mounting the bottom side of inverted flexible PIFA to a mounting surface; and
the bottom-side radiating element is along the inner surface of the bottom side such that the bottom-side radiating element is configured to radiate outwardly through bottom side and the adhesive along the outer surface of the bottom side.

4. The inverted flexible PIFA of claim 3, wherein the inverted flexible PIFA is internally adhesively mountable, via the adhesive, along an inner surface of a forward-facing part of an enclosure, whereby the bottom-side radiating element is operable for radiating forwardly through the forward-facing part of the enclosure when the inverted flexible PIFA is adhesively mounted to the inner surface of the forward-facing part of the enclosure.

5. The inverted flexible PIFA of claim 3, wherein the inverted flexible PIFA is internally adhesively mountable, via the adhesive, along an inner surface of a top-facing part of an enclosure, whereby the bottom-side radiating element is operable for radiating upwardly through the top-facing part of the enclosure when the inverted flexible PIFA is adhesively mounted to the inner surface of the top-facing part of the enclosure.

6. The inverted flexible PIFA of claim 1, wherein:
the inverted flexible PIFA comprises a flexible printed circuit board (PCB) having a metal layer on a first side that is covered by a cover layer, the flexible PCB comprising a second side opposite the first side; and
the second side is foldable or bendable to form the bottom-side radiating element and a top-side ground plane spaced apart from and/or generally parallel to each other such that the bottom-side radiating element and the top-side ground plane are defined by the flexible PCB.

7. The inverted flexible PIFA of claim 6, wherein the second side is foldable or bendable relative to a dielectric to form the bottom-side radiating element and the top-side ground plane spaced apart from and/or generally parallel to each other.

8. The inverted flexible PIFA of claim 7, wherein the dielectric comprises foam or air.

9. The inverted flexible PIFA of claim 6, wherein the inverted flexible PIFA comprises a flexible dielectric element around which the second side is foldable or bendable to form the bottom-side radiating element and the top-side ground plane spaced apart from and/or generally parallel to each other.

10. The inverted flexible PIFA of claim 6, wherein the flexible PCB is configured such that the inverted flexible PIFA is freestanding and/or self-supporting such that air is the only dielectric between the bottom-side radiating element and the top-side ground plane.

11. The inverted flexible PIFA of claim 6, wherein the inverted flexible PIFA comprises an antenna performance when electrically connected to a wireless device that is maintained when the flexible PCB is bent into a concave shape or into a convex shape.

12. The inverted flexible PIFA of claim 6, wherein the inverted flexible PIFA comprises a cable having a first end electrically connected to the metal layer and having a second end adapted to electrically connect to a wireless device.

13. The inverted flexible PIFA of claim 1, wherein the inverted flexible PIFA comprises a flex circuit that includes or defines the bottom-side radiating element and a top-side ground plane spaced apart from and/or generally parallel to the bottom-side radiating element.

14. The inverted flexible PIFA of claim 13, wherein the flex circuit is foldable or bendable into a generally U-shaped configuration in which the bottom-side radiating element and the top-side ground plane are spaced apart from and/or generally parallel to each other.

15. The inverted flexible PIFA of claim 13, wherein the inverted flexible PIFA comprises an antenna performance when electrically connected to a wireless device that is maintained when the flex circuit is bent into a concave shape or into a convex shape.

16. The inverted flexible PIFA of claim 13, wherein the flex circuit comprises polyimide film and electrical conductor(s) in the polyimide film defining the bottom-side radiating element and the top-side ground plane.

17. The inverted flexible PIFA of claim 13, wherein the flex circuit is foldable or bendable relative to a dielectric to form the bottom-side radiating element and the top-side ground plane spaced apart from and/or generally parallel to each other.

18. The inverted flexible PIFA of claim 17, wherein the dielectric comprises foam or air.

19. The inverted flexible PIFA of claim 13, wherein the inverted flexible PIFA comprises a flexible dielectric element around which the flex circuit is foldable or bendable to form the bottom-side radiating element and the top-side ground plane spaced apart from and/or generally parallel to each other.

20. The inverted flexible PIFA of claim 13, wherein the flex circuit is configured such that the inverted flexible PIFA is freestanding and/or self-supporting such that air is the only dielectric between the bottom-side radiating element and the top-side ground plane.

21. The inverted flexible PIFA of claim 13, wherein the flex circuit is thermoformed such that the inverted flexible PIFA is freestanding and/or self-supporting without requiring a flexible dielectric support between the bottom-side radiating element and the top-side ground plane.

22. The inverted flexible PIFA of claim 1, wherein the inverted flexible PIFA comprises a coaxial launch and an alternative solder tab launch located along an edge of the inverted flexible PIFA that connects the bottom-side radiating element and a top-side ground plane of the inverted flexible PIFA for reducing distortion of an antenna feedpoint when the inverted flexible PIFA is bent into a concave shape or into a convex shape.

23. The inverted flexible PIFA of claim 1, wherein the inverted flexible PIFA is configured to be operable with an antenna performance when electrically connected to a wireless device that is maintained when the inverted flexible PIFA is in use.

24. An antenna system comprising the inverted flexible PIFA of claim 1 and a flexible PIFA including a top-side radiating element, wherein the antenna system is configured such that the bottom-side radiating element of the inverted flexible PIFA and the top-side radiating element of the flexible PIFA are respectively operable with oppositely directed radiation outwardly away from a mounting surface, thereby providing the antenna system with dissimilar (uncorrelated) radiated patterns for coverage redundancy for diversity and MIMO operations.

25. A flexible PIFA comprising a flex circuit defining a radiating element and a ground plane spaced apart from and/or generally parallel with the radiating element, wherein the flex circuit is configured and/or thermoformed such that the flexible PIFA is freestanding and/or self-supporting without requiring a flexible dielectric support between the radiating element and the ground plane, thereby allowing the use of air as the only dielectric between the radiating element and the ground plane.

26. A method for providing a flexible planar inverted “F” antenna (PIFA) that includes a flexible printed circuit board (PCB) having a metal layer on a first side that is covered by a cover layer and that can operate when secured to a curved surface, the method comprising folding a second side of the flexible PCB that is opposite the first side to form a bottom-side radiating element and a top-side ground plane that are spaced apart from and/or generally parallel to each other such that the bottom-side radiating element and the top-side ground plane are defined by the flexible PCB.

27.-34. (canceled)
